(19) United States
(12) Patent Application Publication
(10) Pub. No.: US 2026/0217932 A1
(43) Pub. Date: Jul. 30, 2026

(54) PHENYL TRIAZINE CO-STABILIZERS FOR STABILIZED POLYURETHANES

(71) Applicant: BASF SE, Ludwigshafen am Rhein (DE)

(72) Inventors: Tania WEYLAND, Kaisten (CH); Cinzia TARTARINI, Pontecchio Marconi BO (IT); Gregor HUBER, Tarrytown, NY (US); Michéle GERSTER, BASEL (CH); Heinz HERBST, Welschneudorf (DE)

(21) Appl. No.: 19/148,251

(22) PCT Filed: Jan. 12, 2024
(86) PCT No.: PCT/EP2024/050662

§ 371 Date: Jul. 15, 2025

(30) Foreign Application Priority Data
Jan. 16, 2023 (EP) 23151689.9

(51) Int. Cl. C08J 9/00; C08K 5/00; C08K 5/17; C08K 5/20; C08K 5/29; C08K 5/315; C08K 5/3435; C08K 5/3475; C08K 5/3492

(52) U.S. Cl. CPC C08J 9/0028; C08K 5/005; C08K 5/17; C08K 5/20; C08K 5/29; C08K 5/315; C08K 5/3435; C08K 5/3475; C08K 5/3492; C08J 2475/04

(57) ABSTRACT

The present invention relates to a composition comprising a polyurethane; at least one UV absorber; at least one hindered amine light stabilizer; and at least one phenyl triazine of formula (A) as defined below. It also relates to a process for stabilizing the polyurethane comprising the steps of incorporating into the polyurethane the at least one UV absorber, the at least one hindered amine light stabilizer, and the at least one phenyl triazine of formula (A); and to a mixture comprising the at least one UV absorber, the at least one hindered amine light stabilizer, and the at least one phenyl triazine of formula (A) as stabilizer against degradation by light, oxygen wand/or heat of the polyurethane.

The present invention relates to a composition comprising a polyurethane; at least one UV absorber; at least one hindered amine light stabilizer; and at least one phenyl triazine of formula (A) as defined below. It also relates to a process for stabilizing the polyurethane comprising the steps of incorporating into the polyurethane the at least one UV absorber, the at least one hindered amine light stabilizer, and the at least one phenyl triazine of formula (A); and to a mixture comprising the at least one UV absorber, the at least one hindered amine light stabilizer, and the at least one phenyl triazine of formula (A) as stabilizer against degradation by light, oxygen and/or heat of the polyurethane. Combinations of preferred embodiments with other preferred embodiments are within the scope of the present invention.

Polyurethanes can be used in a broad range of applications requiring light stabilizers, ranging from industrial applications like conveyor belts, sport & leisure applications (e.g. sport shoes, sky boots, sky films) and automotive applications (artificial leather for Instrument panel, door panels, seat covers). There is an ongoing need to further improve the light stabilizers, e.g. to find light stabilizers which are not classified as PBT (persistent, bioaccumulative and toxic) or as vPvB (very persistent and very bio-accumulative) or as SVHC (Substances of Very High Concern), to find stabilizers which deliver a long term good light stability, and to find stabilizers which are low cost. Another object was to further improve the long term light stabilization of polyurethanes, which are already stabilized with a UV absorber, preferably at a low cost.

The objects were achieved by a composition comprising
a polyurethane;
at least one UV absorber;
at least one hindered amine light stabilizer; and
at least one phenyl triazine of formula (A)

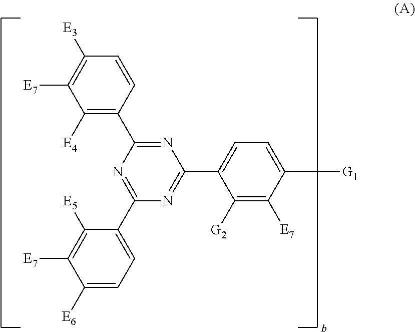

wherein
G₁ is —O-E₁, phenyl, or phenyl substituted by 1, 2 or 3 C₁-C₄alkyl,
G₂ is —O-E₂ when G₁ is —O-E₁, or H when G₁ is not —O-E₁,
E₁ is hydrogen, C₁-C₁₈ alkyl, C₃-C₅₀ alkyl interrupted by oxygen, C₃-C₅₀ hydroxyalkyl interrupted by oxygen, or a group of formula P

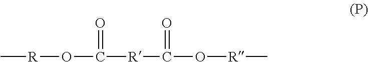

wherein, R, R′ and R″ independently of one another are C₁-C₁₈ alkylene,
b is an integer in the range of 1 to 3, or a group of formula Q

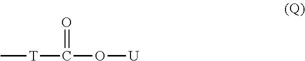

wherein T and U independently of one another are linear or branched C₁-C₁₈ alkyl,
wherein b is 1 when G₁ is phenyl, or phenyl substituted by 1, 2 or 3 C₁-C₄ alkyl, E₂, E₃, E₄, E₅, and E₆ independently of one another are hydrogen, hydroxy, C₁-C₁₈ alkyl,
phenyl or phenyl substituted by 1, 2 or 3 C₁-C₄alkyl, or a group of formula Q

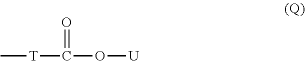

wherein, T and U independently of one another are linear or branched C₁-C₁₈ alkyl,
and
E₇ independently of one another are hydrogen, or C₁-C₁₈ alkyl.

The objects were also achieved by a process for preparing the composition, comprising the steps of contacting the polyurethane and
the at least one UV absorber,
the at least one hindered amine light stabilizer, and
the at least one phenyl triazine of formula (A).

The objects were also achieved by a process for stabilizing the polyurethane comprising the steps of incorporating into the polyurethane
the at least one UV absorber,
the at least one hindered amine light stabilizer, and
the at least one phenyl triazine of formula (A).

The objects were also achieved by a use of a mixture comprising
a at least one UV absorber,
a at least one hindered amine light stabilizer, and
a at least one phenyl triazine of formula (A)
as stabilizer against degradation by light, oxygen and/or heat of the polyurethane.

In an embodiment, G₁ is —O-E₁ and G₂ is —OE₂.

In an embodiment, G₁ is phenyl, or phenyl substituted by 1, 2 or 3 C₁-C₄alkyl, and G₂ is H.

In an embodiment, E₁ is hydrogen, C₁-C₁₈ alkyl, a group of Formula P, or a group of formula (Q), preferably hydrogen, C₁-C₈ alkyl, a group of formula (P) wherein, R, R′ and R″ independently of one another are C₁-C₁₈ alkylene, preferably R, R′ and R″ independently of one another are C₂-C₁₀ alkylene, b is an integer in the range of 1 to 3, preferably b is an integer in the range of 1 to 2, or a group of formula (Q).

In an embodiment, when b is 1 then E₁ is hydrogen, alkyl, or a group of formula (Q) and when b is 2 then E₁ is group of formula (P). Preferably, b is 1.

In an embodiment, E₂, E₃, E₄, E₅, and E₆ independently of one another are hydrogen, C₁-C₁₈ alkyl, phenyl or phenyl substituted by 1, 2 or 3 C₁-C₄alkyl, or a group of formula (Q), preferably E₂, E₃, E₄, E₅, and E₆ independently of one another are hydrogen, C₁-C₄ alkyl, phenyl, or a group of formula (Q).

Suitable C₁-C₁₈ alkyl are linear or branched C₁-C₁₈ alkyl, such as methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl and octadecyl.

Suitable C₁-C₁₈ alkylene are linear or branched C₁-C₁₈ alkylene, such as methylene, ethylene, propylene, isopropylene, n-butylene, sec-butylene, isobutylene, tert-butylene, 2-ethylbutylene, n-pentylene, isopentylene, 1-methylpentylene, 1,3-dimethylbutylene, n-hexylene, 1-methylhexylene, n-heptylene, isoheptylene, 1,1,3,3-tetramethylbutylene, 1-methylheptylene, 3-methylheptylene, n-octylene, 2-ethylhexylene, 1,1,3-trimethylhexylene, 1,1,3,3-tetramethylpentylene, nonylene, decylene, undecylene, 1-methylundecylene, dodecylene, 1,1,3,3,5,5-hexamethylhexylene, tridecylene, tetradecylene, pentadecylene, hexadecylene, heptadecylene and octadecylene.

In an embodiment, E₇ is hydrogen. In another embodiment, E₇ is C₁-C₁₈ alkyl, preferably methyl.

Preferably, the phenyl triazine of formula (A) is selected from the formulae (A1), (A2), (A3), (A4), (A5), (A6), and (A7):

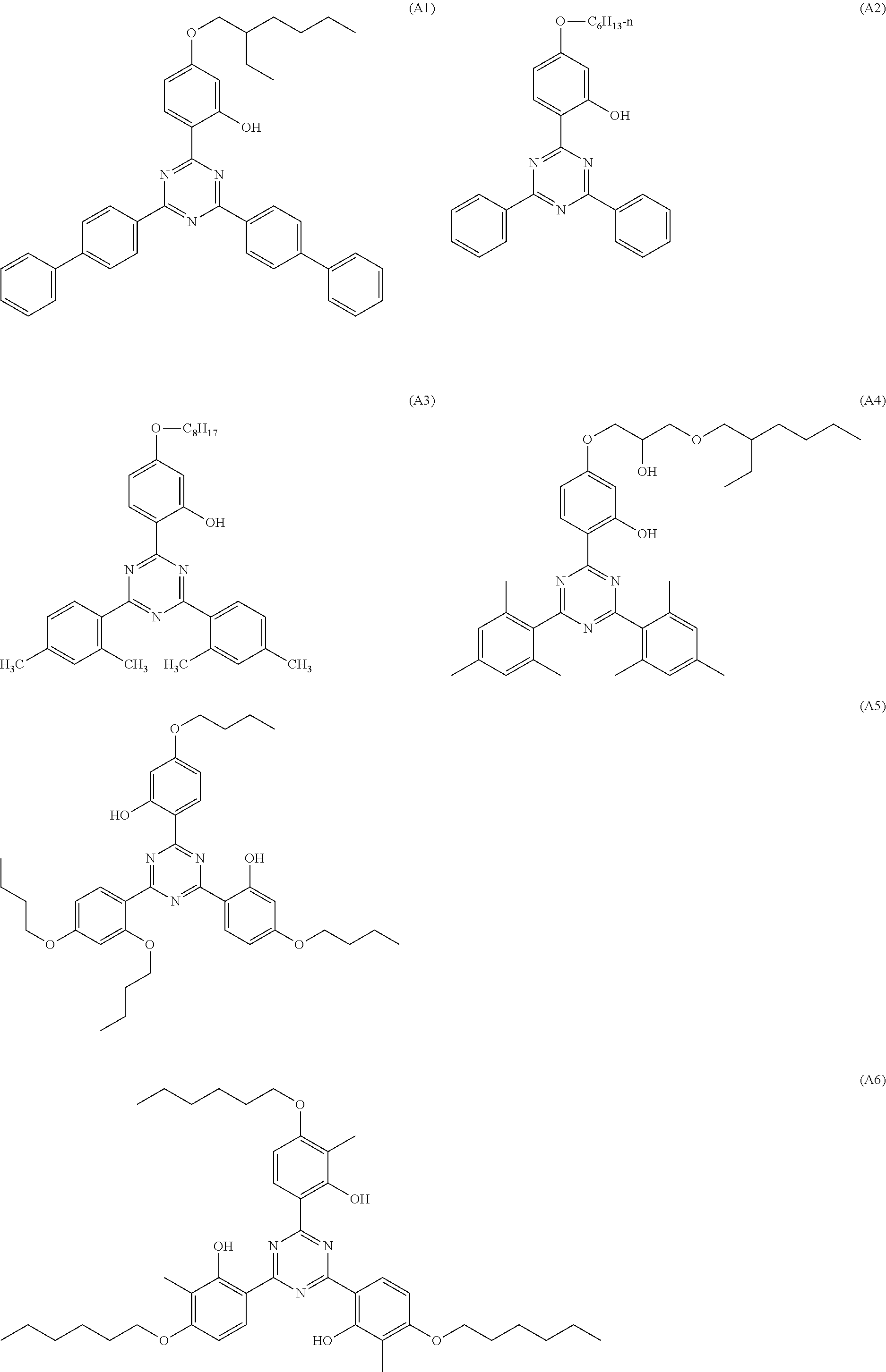

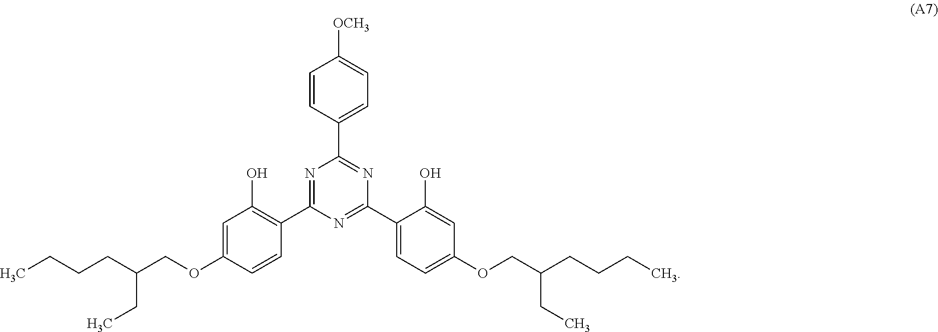 [SMILES: CCCCC(CC)COc1ccc(-c2nc(-c3ccc(OC)cc3)nc(-c3ccc(OCC(CC)CCCC)cc3O)n2)c(O)c1]

In another preferred form the phenyl triazine of formula (A) is selected from the formula (A1).

In another preferred form the phenyl triazine of formula (A) is selected from the formula (A2).

In another preferred form the phenyl triazine of formula (A) is selected from the formula (A3).

In another preferred form the phenyl triazine of formula (A) is selected from the formula (A4).

In another preferred form the phenyl triazine of formula (A) is selected from the formula (A5).

In another preferred form the phenyl triazine of formula (A) is selected from the formula (A6).

In another preferred form the phenyl triazine of formula (A) is selected from the formula (A7).

The composition comprises the phenyl triazine of formula (A) in a total amount of 0.001 to 5.0 wt %, preferably 0.01 to 1.0 wt %, and in particular 0.05 to 0.5 wt %.

The composition comprises the phenyl triazine of formula (A) in a total amount of p to 5.0 wt %, preferably up to 1.0 wt %, and in particular up to 0.5 wt %.

The composition comprises the phenyl triazine of formula (A) in a total amount of at least 0.001 wt %, preferably at least 0.01 wt %, and in particular at least 0.05 wt %.

The UV absorber can be selected from the group consisting of 2-(2′-hydroxyphenyl)benzotriazoles, 2-hydroxybenzophenones, esters of substituted and unsubstituted benzoic acids, cyanoacrylates, formamidine, oxanilides, malonates, and mixtures thereof.

The UV absorber is preferably selected from the group consisting of 2-(2′-hydroxyphenyl)benzotriazoles, cyanoacrylates, formamidine, oxanilides, and mixtures thereof.

Preferred UV absorbers are the selected from the UV absorbers of the formulae (U1) to (U7)

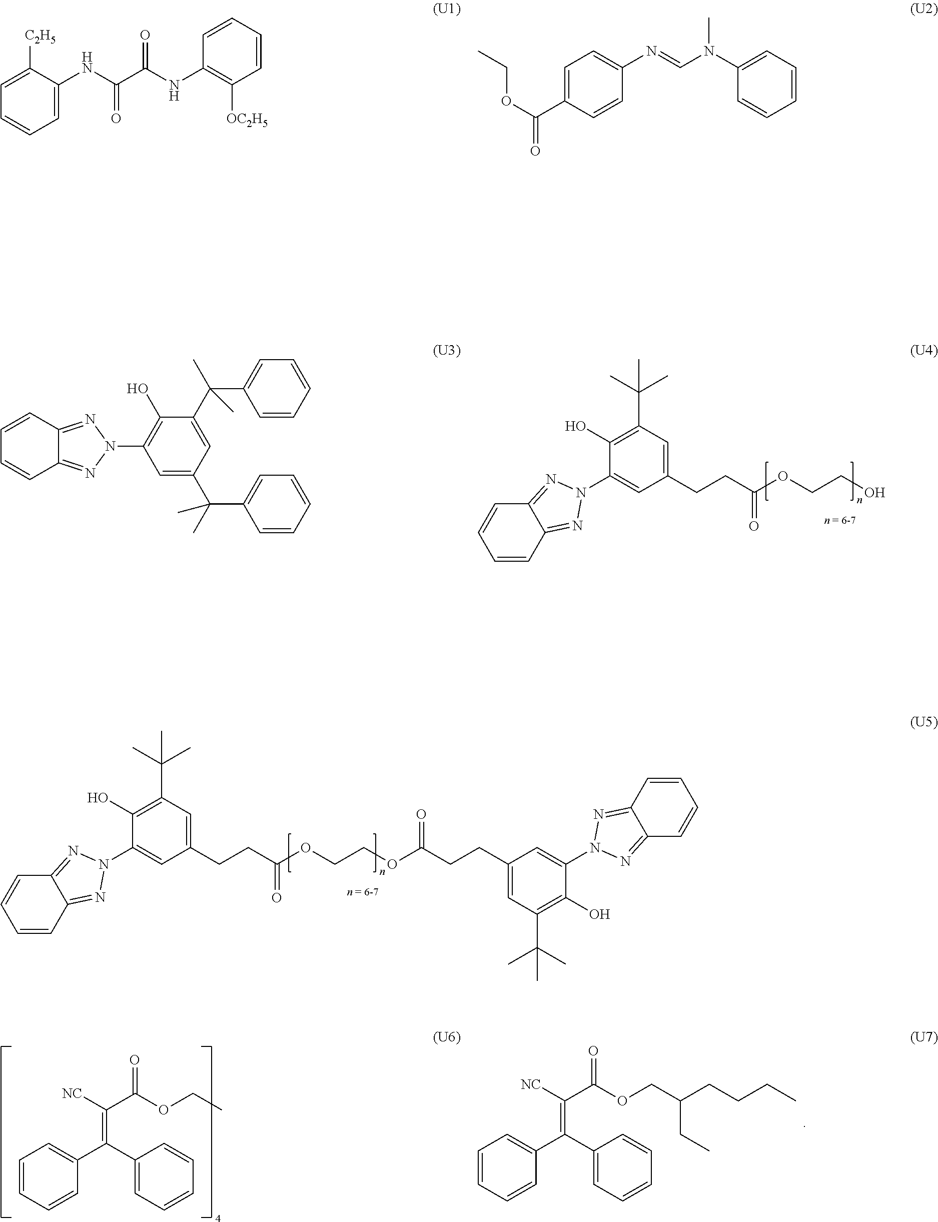

In another preferred form the UV absorber is selected from the formula (U1).

In another preferred form the UV absorber is selected from the formula (U2).

In another preferred form the UV absorber is selected from the formula (U3).

In another preferred form the UV absorber is selected from the formula (U4).

In another preferred form the UV absorber is selected from the formula (U5).

In another preferred form the UV absorber is selected from a mixture of the formula (U4) and (U5).

In another preferred form the UV absorber is selected from the formula (U6).

In another preferred form the UV absorber is selected from the formula (U7).

The composition comprises the UV absorber in a total amount of 0.001 to 10.0 wt %, preferably 0.1 to 3.0 wt %, and in particular 0.4 to 1.5 wt %.

The composition comprises the UV absorber in a total amount of up to 10.0 wt %, preferably up to 3.0 wt %, and in particular up to 1.5 wt %.

The composition comprises the UV absorber in a total amount of at least 0.001 wt %, preferably at least 0.1 wt %, and in particular at least 0.4 wt %.

The composition comprises at least one hindered amine light stabilizer, preferably one or two hindered amine light stabilizer, and in particular one hindered amine light stabilizer.

Suitable hindered amine light stabilizers are known in the art and often commercially available.

Preferred hindered amine light stabilizers are selected from the hindered amine light stabilizers of the formulae (H1), (H2), (H3) and the compound (H4):

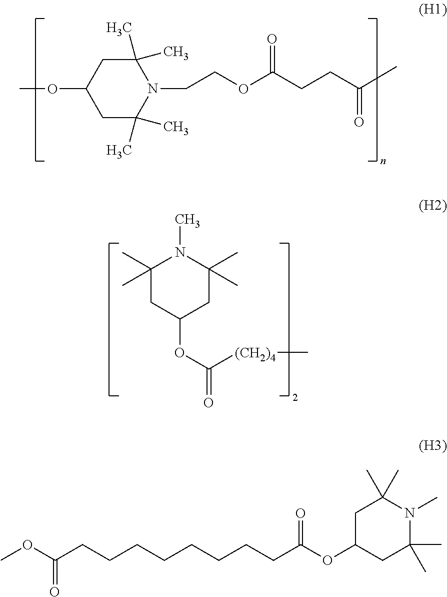

and where the compound (H4) is a reaction product of 1,2,2,6,6-pentamethylpiperidin-4-ol, diethylcarbonate, and ethoxylated trimethylolpropane.

The compound (H4) can be prepared according to Example 1 of WO2009/068492. The ethoxylated trimethylolpropane is preferably obtainable by statistically reacting one mol ethylene oxide per mol of hydroxygroups of trimethylolpropane.

The hindered amine light stabilizers of the formulae (H2) and (H3) can be present as mixtures.

In another preferred form the hindered amine light stabilizer is selected from the formula (H1).

In another preferred form the hindered amine light stabilizer is selected from the formula (H2).

In another preferred form the hindered amine light stabilizer is selected from the formula (H3).

In another preferred form the hindered amine light stabilizer is selected from a mixture of the formulae (H2) and (H3).

In another preferred form the hindered amine light stabilizer is selected from the compound (H4).

In the hindered amine light stabilizers (H1) the n may have a value from 2 to 30, preferably 2 to 10. The molecular weight Mn of the hindered amine light stabilizers (H1) is usually from 2000 to 5000 g/mol, preferably from 2500 to 4500 g/mol.

The composition comprises the hindered amine light stabilizers in a total amount of 0.001 to 10.0 wt %, preferably 0.1 to 3.0 wt %, and in particular 0.4 to 1.5 wt %.

The composition comprises the hindered amine light stabilizers in a total amount of up to 10.0 wt %, preferably up to 3.0 wt %, and in particular up to 1.5 wt %.

The composition comprises the hindered amine light stabilizers in a total amount of at least 0.001 wt %, preferably at least 0.1 wt %, and in particular at least 0.4 wt %.

The composition comprises the UV absorber, the hindered amine light stabilizer and the phenyl triazine of formula (A) in a total amount of 0.01 to 15.0 wt %, preferably 0.3 to 6.0 wt %, and in particular 1.0 to 3.0 wt %.

The composition comprises the UV absorber, the hindered amine light stabilizer and the phenyl triazine of formula (A) in a total amount of up to 15.0 wt %, preferably up to 6.0 wt %, and in particular up to 3.0 wt %.

The composition comprises the UV absorber, the hindered amine light stabilizer and the phenyl triazine of formula (A) in a total amount of at least 0.01 wt %, preferably at least 0.3 wt %, and in particular at least 1.0 wt %.

The weight ratio of the UV absorber to the hindered amine light stabilizers can be from 3:1 to 1:3, preferably 1.8:1 to 1:1.8, and in particular from 1.3:1 to 1:1.3.

The weight ratio of the sum of the UV absorber and the hindered amine light stabilizers to the phenyl triazine of formula (A) can be from 30:1 to 4:1, preferably 15:1 to 7:1, and in particular from 12:1 to 8:1.

The UV absorber and the hindered amine light stabilizers can in sum of their weight be present in an excess of at least 2-fold, 3-fold, 4-fold, 5-fold, 6-fold, 7-fold, 8-fold, or 9-fold to the phenyl triazine of formula (A).

In a preferred form the composition comprises the polyurethane,
the UV absorber of the formula (U1),
the hindered amine light stabilizer of the formula (H1), and
the phenyl triazine for the formula (A4).

In another preferred form the composition comprises the polyurethane,
the UV absorber of the formula (U2),
the hindered amine light stabilizers of the formulae (H2) and (H3), and
the phenyl triazine for the formula (A4).

In another preferred form the composition comprises the polyurethane,
the UV absorber of the formula (U1),
the hindered amine light stabilizers of the formula (H1), and
the phenyl triazine for the formula (A3).

In another preferred form the composition comprises the polyurethane,
the UV absorber of the formula (U3),
the hindered amine light stabilizers of the formula (H1), and
the phenyl triazine for the formula (A1).

In another preferred form the composition comprises the polyurethane,
the UV absorber of the formula (U7),
the hindered amine light stabilizers of the compound (H4), and
the phenyl triazine for the formula (A7).

In another preferred form the composition comprises the polyurethane,
the UV absorber of the formula (U7),
the hindered amine light stabilizers of the compound (H4), and
the phenyl triazine for the formula (A5).

In another preferred form the composition comprises the polyurethane,
the UV absorber of the formulae (U4) and (U5),
the hindered amine light stabilizers of the compound (H4), and
the phenyl triazine for the formula (A1).

In particular, the composition comprises the polyurethane,
the UV absorber selected from the UV absorbers of the formulae (U1), (U2), (U3), (U4), (U5), and (U7);
the hindered amine light stabilizer selected from the hindered amine light stabilizer of the formulae (H1), (H2), (H3), and the compound (H4); and
the phenyl triazine selected from the formulae (A1), (A2), (A3), and (A4).

In particular, the composition comprises the polyurethane,
the UV absorber selected from the UV absorbers of the formulae (U1), (U2), (U3), (U4), (U5), and (U7);
the hindered amine light stabilizer selected from the hindered amine light stabilizer of the formulae (H1), (H2), (H3), and the compound (H4); and
the phenyl triazine selected from the formulae (A1), (A2), (A3), and (A7).

In a preferred form the composition comprises the polyurethane,
the UV absorber of the formula (U1),
the hindered amine light stabilizer of the formula (H1), and
the phenyl triazine for the formula (A4), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formula (U2),
the hindered amine light stabilizers of the formulae (H2) and (H3), and
the phenyl triazine for the formula (A4), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formula (U1),
the hindered amine light stabilizers of the formula (H1), and
the phenyl triazine for the formula (A3), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formula (U3),
the hindered amine light stabilizers of the formula (H1), and
the phenyl triazine for the formula (A1), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formula (U7),
the hindered amine light stabilizers of the compound (H4), and
the phenyl triazine for the formula (A7), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formula (U7),
the hindered amine light stabilizers of the compound (H4), and
the phenyl triazine for the formula (A5), and
   the weight ratio of the sum of the UV absorber and the hindered amine light stabilizers to the phenyl triazine is from 30:1 to 4:1, preferably 15:1 to 7:1, and in particular from 12:1 to 8:1.

In another preferred form the composition comprises the polyurethane,
the UV absorber of the formulae (U4) and (U5),
the hindered amine light stabilizers of the compound (H4), and
the phenyl triazine for the formula (A1), and
   the weight ratio of the sum of the UV absorber and the hindered amine light stabilizers to the phenyl triazine is from 30:1 to 4:1, preferably 15:1 to 7:1, and in particular from 12:1 to 8:1.

In a preferred form the composition comprises the polyurethane,
the UV absorber of the formula (U1),
the hindered amine light stabilizer of the formula (H1), and
the phenyl triazine for the formula (A4), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formula (U2),
the hindered amine light stabilizers of the formulae (H2) and (H3), and
the phenyl triazine for the formula (A4), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formula (U1),
the hindered amine light stabilizers of the formula (H1), and
the phenyl triazine for the formula (A3), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formula (U3),
the hindered amine light stabilizers of the formula (H1), and
the phenyl triazine for the formula (A1), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formula (U7),
the hindered amine light stabilizers of the compound (H4), and
the phenyl triazine for the formula (A7), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formula (U7),
the hindered amine light stabilizers of the compound (H4), and
the phenyl triazine for the formula (A5), and
   the weight ratio of the UV absorber to the hindered amine light stabilizers is from 3:1 to 1:3, preferably 1.8:1 to 1:1.8, and in particular from 1.3:1 to 1:1.3.

In another preferred form the composition comprises the polyurethane,
the UV absorber of the formulae (U4) and (U5),
the hindered amine light stabilizers of the compound (H4), and
the phenyl triazine for the formula (A1), and
   the weight ratio of the UV absorber to the hindered amine light stabilizers is from 3:1 to 1:3, preferably 1.8:1 to 1:1.8, and in particular from 1.3:1 to 1:1.3.

The invention also relates to the use of the mixture comprising
a at least one UV absorber,
a at least one hindered amine light stabilizer, and
a at least one phenyl triazine of formula (A)
   as stabilizer against degradation by light, oxygen and/or heat of the polyurethane.

The weight ratio of the sum of the UV absorber and the hindered amine light stabilizers to the phenyl triazine of formula (A) in the mixture may be from 30:1 to 4:1, preferably 15:1 to 7:1, and in particular from 12:1 to 8:1.

The weight ratio of the UV absorber to the hindered amine light stabilizers in the mixture can be from 3:1 to 1:3, preferably 1.8:1 to 1:1.8, and in particular from 1.3:1 to 1:1.3.

In a preferred form the mixture comprises
the UV absorber of the formula (U1),
the hindered amine light stabilizer of the formula (H1), and
the phenyl triazine for the formula (A4), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formula (U2),
the hindered amine light stabilizers of the formulae (H2) and (H3), and
the phenyl triazine for the formula (A4), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formula (U1),
the hindered amine light stabilizers of the formula (H1), and
the phenyl triazine for the formula (A3), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formula (U3),
the hindered amine light stabilizers of the formula (H1), and
the phenyl triazine for the formula (A1), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formula (U7),
the hindered amine light stabilizers of the compound (H4), and
the phenyl triazine for the formula (A7), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formula (U7),
the hindered amine light stabilizers of the compound (H4), and
the phenyl triazine for the formula (A5), and
   the weight ratio of the UV absorber to the hindered amine light stabilizers is from 3:1 to 1:3, preferably 1.8:1 to 1:1.8, and in particular from 1.3:1 to 1:1.3.

In another preferred form the mixture comprises
the UV absorber of the formulae (U4) and (U5),
the hindered amine light stabilizers of the compound (H4), and
the phenyl triazine for the formula (A1), and
   the weight ratio of the UV absorber to the hindered amine light stabilizers is from 3:1 to 1:3, preferably 1.8:1 to 1:1.8, and in particular from 1.3:1 to 1:1.3.

A polyurethane can be obtained from the reaction of a polyisocyanate reactant and a polyol reactant in a reaction mixture.

The polyurethane can be an aromatic or an aliphatic polyurethane, preferably an aromatic polyurethane.

The polyurethane can be a polyurethane foam, a thermoplastic polyurethane (e.g. an aromatic or an aliphatic thermoplastic polyurethane), or a polyurethane coating.

Preferably, the polyurethane is a thermoplastic polyurethane, in particular an aromatic thermoplastic polyurethane.

The polyisocyanate reactant is an aromatic polyisocyanate or an aliphatic polyisocyanate. An aromatic polyisocyanate is for example 2,4- and/or 2,6-toluene diisocyanate (TDI), 2,4′-diphenylmethanediisocyanate, 1,3- and 1,4-phenylene diisocyanate, 4,4′-diphenylmethane diisocyanate (MDI), 2,4′-diphenylmethane diisocyanate (often contained as a minor isomer in 4,4′-diphenylmethane diisocyanate), 1,5-naphthylene diisocyanate, triphenylmethane-4,4′,4″triisocyanate or polyphenyl-polymethylene polyisocyanates, for example polyisocyanates as prepared by aniline-formaldehyde condensation followed by phosgenization (“crude MDI”). Mixtures of aromatic polyisocyanates are also included. An aliphatic polyisocyanate is for example ethylene diisocyanate, 1,4-tetramethylene diisocyanate, 1,6-hexamethylene diisocyanate, 1,12-dodecane diisocyanate, cyclobutene-1,3-diisocyanate, cyclohexane-1,3- and 1,4-diisocyanate, 1,5-diisocyanate-3,3,5-trimethylcyclohexane, 2,4- and/or 2,6-hexahydrotoluene diisocyanate, perhydro-2,4′- and/or 4,4′-diphenylmethanediisocyanate (H12MDI) or isophorone diisocyanate. Mixtures of aliphatic polyisocyanates are also included. In addition, derivatives and prepolymers of the foregoing aromatic polyisocyanate or aliphatic polyisocyanate are included, for example these containing urethane, carbodiimide, allophanate, isocyanurate, acylated urea, biuret or ester groups (“modified polyisocyanates”). For an aromatic polyisocyanurate, the so-called “liquid MDI” products which contain carbodiimide groups are an example. It is also possible to employ the isocyanate group-containing distillation residues of aromatic polyisocyanates or aliphatic polyisocyanates, as it is or dissolved in one or more of the abovementioned polyisocyanates, which are obtained in the course of the industrial preparation of isocyanates. Preferred polyisocyanate reactants are the aromatic polyisocyanates TDI, MDI or derivatives of MDI, and the aliphatic polyisocyanates isophorone diisocyanate, H12MDI, hexamethylene diisocyanate or cyclohexane diisocyanate. Very preferred are aromatic polyisocyanates. Most preferred is a polyisocyanate, which is TDI, MDI or a derivative of MDI. Especially preferred is a polyisocyanate, which is TDI, particularly a mixture of 2,4-toluene diisocyanate and 2,6-toluene diisocyanate.

The polyisocyanate reactant is preferably used in an amount to provide an isocyanate index of 90 to 130, more preferably 95 to 115, most preferably 100 to 113 and especially preferably 105 to 112. The isocyanate index is used herein to mean 100 times the ratio of the used isocyanate groups relative to the theoretical equivalent amount needed to react with the active hydrogen equivalents in the reaction mixture, e.g. in the polyol reactant and—if present—in water, carboxylic acid, crosslinker, chain extender and in other components with a functional group, which is an active hydrogen-containing group and thus is reactive towards an isocyanate group. An index 100 indicates a stoichiometry 1 to 1 and an index 107 indicates for example a 7% excess of isocyanate equivalents. Isocyanate equivalents are the overall number of isocyanate groups. Active hydrogen equivalents means the overall number of active hydrogens. An active hydrogen-containing group, which is a hydroxyl group or a secondary amine group, contributes one active hydrogen equivalent. An active hydrogen-containing group, which is a primary amine group, contributes also one active hydrogen equivalent. This is because after reaction with one isocyanate group, the second original hydrogen is no longer an active hydrogen. An active hydrogen-containing group, which is a carboxylic acid, contributes one active hydrogen equivalent for one carboxylic acid functionality.

The polyol reactant is a polyether polyol or a polyester polyol.

The polyether polyol is for example a polymer obtainable by polymerization of alkylene oxides or cyclic ethers with at least 4 ring atoms, which contains at least two active hydrogen-containing groups per molecule and at least two the contained active hydrogen-containing groups per molecule are hydroxyl groups. An active hydrogen-containing group is for example a primary hydroxyl group, a secondary hydroxyl group, a primary amine or a secondary amine. The intended function of the active hydrogen-containing group is the reaction with an isocyanate to form a covalent bond therewith. Preferably, the polyether polyol contains 2 to 8 active hydrogen-containing groups per molecule, very preferably 2 to 6, and most preferably 2 to 4 and especially preferably 2 to 3. A number of three active hydrogen-containing groups per molecule in the polyether polyol is also called a trifunctional polyether polyol. Alkylene oxides are for example ethylene oxide, propylene oxide, 1,2-butylene oxide, 2,3-butylene oxide or styrene oxide. Cyclic ethers are for example oxetane or tetrahydrofuran.

The polyether polyol is prepared for example by polymerizing alkylene oxides, alone or as a mixture or in succession, with initiator components containing at least two reactive hydrogen atoms. An initiator component containing at least two reactive hydrogen atoms is for example water, a polyalcohol, ammonia, a primary amine or a secondary amine containing a second reactive hydrogen atom. A polyalcohol is for example ethylene glycol, propane-1,2-diol, propane-1,3-diol, glycerine, trimethylolpropane, 4,4′-dihydroxydiphenylpropane or alphamethylglucoside. A primary amine is for example ethanolamine, ethylene diamine, diethylenetriamine or aniline. A secondary amine containing a second reactive hydrogen atom is for example diethanolamine, triethanolamine or N-(2-hydroxyethyl) piperazine. The initiator component containing at least two reactive hydrogen atoms is preferably water or a polyalcohol. The initiator component containing at least two reactive hydrogen atoms contains preferably 2 to 6 reactive hydrogen atoms, more preferably 2 to 4 and most preferably 2 to 3. The average number of reactive hydrogen atoms in the initiator component used in preparing the polyether polyol defines a “nominal functionality” of the polyether polyol, i.e. the average number of active hydrogen-containing groups of the polyether polyol. The nominal functionality of the polyether polyol is preferably from 2 to 6, more preferably from 2 to 4, most preferably from 2 to 3.5 and especially preferably from 2 to 3.3.

The polyether polyol has for example a molecular weight of 400 to 10000 Dalton, preferably 800 to 10000 Dalton. The molecular weight is more preferably determined as the number average molecular weight (Mₙ or number average molar mass). Equivalent weight of the polyether polyol is defined herein as the molecular weight of the polyether polyol divided by its average number of active hydrogen-containing groups per molecule, preferably the number average molecular weight (Mₙ) is taken for determination of the equivalent weight. The equivalent weight of the polyether polyol, especially determined with the number average molecular weight (Mₙ), is preferably 400 to 5000, more preferably 800 to 2500, very preferably 900 to 1300 and especially preferably 1000 to 1200.

Preferred is a polyether polyol, which contains pre-dominantly (up to 90% by weight, based on all the hydroxyl groups present in the polyether polyol) active hydrogen-containing groups, which are secondary hydroxyl groups.

A polyester polyol is produced for example by polycondensation of a diacid and a diol, wherein the diol is applied in excess. Partial replacement of the diol by a polyol with more than two hydroxyl groups leads to a ramified polyester polyol. A diacid is for example adipic acid, glutaric acid, succinic acid, maleic acid or phthalic acid. A diol is for example ethylene glycol, diethylene glycol, 1,4-butane diol, 1,5-pentane diol, neopentyl glycol or 1,6-hexane diol. A polyol with more than two hydroxyl groups is for example glycerine, trimethylol propane or pentaerythritol.

A crosslinker is for example a further component of the reaction mixture. A crosslinker can improve the resiliency of the polyurethane. A crosslinker as defined herein possesses three 3 to 8, preferably 3 to 4 active hydrogen-containing groups per molecule. The crosslinker thus reacts with the polyisocyanate reactant and if present is considered as a reactant for calculation of the polyisocyanate index. The crosslinker is free of an ester bond and possesses an equivalent weight, especially determined with the number average molecular weight (Mₙ), of below 200. In case of the presence of a crosslinker, the polyether polyol possesses preferably an equivalent weight of the polyether polyol, especially determined with the number average molecular weight (Mₙ), of 400 to 5000. A crosslinker is for example an alkylene triol or an alkanolamine. An alkylene triol is for example glycerine or trimethylolpropane. An alkanolamine is for example diethanolamine, triisopropanolamine, triethanolamine, diisopropanolamine, an adduct of 4 to 8 moles of ethylene oxide with ethylene diamine or an adduct of 4 to 8 moles of propylene oxide with ethylene diamine. The crosslinker is preferably an alkanolamine, more preferably diethanolamine.

A chain extender is for example a further component of the reaction mixture. A chain extender as defined herein possesses two active hydrogen-containing groups per molecule, which are hydroxyl groups. The chain extender thus reacts with the polyisocyanate reactant and if present is considered as a reactant for calculation of the polyisocyanate index. The chain extender is free of an ester bond and possesses an equivalent weight, especially determined with the number average molecular weight (Mₙ), of between 31 and 300, preferably 31 to 150. In case of the presence of a chain extender, the polyether polyol possesses preferably an equivalent weight, especially determined with the number average molecular weight (Mₙ), of 400 to 5000. A chain extender is for example an alkylene glycol or a glycol ether. An alkylene glycol is for example ethylene glycol, 1,3-propylene glycol, 1,4-butylene glycol or 1,6-hexamethylene glycol. A glycol ether is for example diethylene glycol, triethylene glycol, dipropylene glycol, tripropylene glycol or 1,4-cyclohexanedimethanol.

If used, the combined amount of crosslinker and the chain extender in the reaction mixture is below 50 parts by weight based on 100 parts by weight of the polyol reactant. The combined amount is preferably below 20 parts by weight, more preferably below 5 parts by weight.

The reaction mixture prior to the reaction comprises a polyisocyanate reactant and a polyol reactant, and 60 to 100 parts by weight of the polyol reactant based on 100 parts by weight of the polyol reactant is preferably a polyether polyol. More preferably, 80 to 100 parts by weight of the polyol reactant is a polyether polyol, very preferably 95 to 100 parts by weight, most preferably 98 to 100 parts by weight and especially preferably, the polyol reactant is a polyether polyol.

The polyurethane is obtained from the reaction of the reaction mixture. The aforementioned preference can be expressed in an alternative form, i.e. the polyurethane is preferably obtained from the reaction of a polyisocyanate reactant and a polyol in a reaction mixture, and 60 to 100 parts by weight of the polyol reactant based on 100 parts by weight of the polyol reactant, which is a polyether polyol.

A catalyst for the reaction of the polyisocyanate reactant and the polyol reactant is preferably added to the reaction mixture. The catalyst is for example an amine catalyst or an organometallic catalyst. An amine catalyst is for example triethylenediamine or a derivative based on it, N-methyl morpholine, N-ethyl morpholine, diethyl ethanolamine, N-coco morpholine, 1-methyl-4-dimethylaminoethyl piperazine, 3-methoxy-N-dimethylpropylamine, N,N-diethyl-3-diethylaminopropylamine, dimethylbenzyl amine, bis-(2-dimethylaminoethyl) ether or dimethylbenzyl amine. Preferred is a triethylenediamine or a derivative based on it. An organometallic catalyst is for example an organic salt of tin, bismuth, iron, mercury, zinc or lead. Preferred is an organotin compound. Examples for an organotin compound are dimethyl tin dilaurate, dibutyl tin dilaurate or stannous octoate. Preferred is stannous octoate. Preferably, the amount of an amine catalyst is from 0.01 to 5 parts by weight based on 100 parts by weight of the polyol reactant, more preferably is an amount of 0.03 to 2 parts by weight. Preferably, the amount of an organometallic catalyst is from 0.001 to 3 parts by weight based on 100 parts by weight of the polyol reactant. Preferably, an amine catalyst and an organometallic catalyst are added to the reaction mixture.

For generation of the polyurethane foam, a gas generation takes place during the reaction. The gas generation during the reaction can be caused by an addition of water or a carboxylic acid to the reaction mixture prior to the reaction for a chemical gas generation or by an addition of a blowing agent to the reaction mixture prior to the reaction.

A blowing agent as used herein means an organic compound, which has a boiling point at 101.32 kPa of between −15° C. and at or below the maximum temperature generated during the reaction of the reaction mixture, preferably between −15° C. and 110° C., more preferably between −10° C. and 80° C. and very preferably between −5° C. and 70° C. Furthermore, the blowing agent does not react under formation of a chemical bond with the polyisocyanate reactant or the polyol reactant in the reaction mixture under the conditions of the reaction. Examples for a blowing agent are alkanes having from 4 to 10 carbon atoms, preferably 5 to 8 carbon atoms, cycloalkanes having from 5 to 10 carbon atoms, acetone, methyl formate, carbon dioxide (added in liquid form) or partially or fully halogenated alkanes having from 1 to 5 carbon atoms, preferably 1 to 3 carbon atoms.

Alkanes having from 4 to 10 carbon atoms are for example butane, pentane, hexane, or heptane. Cycloalkanes having from 5 to 10 carbon atoms are for example cyclopentane or cyclohexane. Partially or fully halogenated alkanes are for example methylene chloride 1,1,1-trichlorethane, CFC-11, CFC-113, CFC-114, CFC-123, CFC-123a, CFC-124, CFC-133, CFC-134, CFC-134a, CFC-141b, CFC-142, CFC-151. From the partially or fully halogenated alkanes having from 1 to 5 carbon atoms, the partially halogenated ones, i.e. those having at least one hydrogen atom, are preferred, for example methylene chloride, CFC-123, CFC-141b, CFC-124 or 1,1,1-trichorloethane.

When water is used for the gas generation, water is preferably added to the reaction mixture prior to the reaction in an amount from 0.5 to 12 parts by weight based on 100 parts by weight of the polyol reactant. More preferably, 1 to 8 parts of water are added. Most preferably, 2 to 7 parts of water are added, for example 3 to 7 or 4 to 7 parts of water. Particularly for a polyurethane foam having a density between 16 and 32 kg/m³, 3 to 8 parts water are added. For a polyurethane foam having a density above 32 kg/m³ and below 48 kg/m³, 2 to 5 parts of water are added.

When a blowing agent is used for the gas generation, the blowing agent is preferably added to the reaction mixture in an amount from 2 to 50 parts by weight based on 100 parts by weight of the polyol reactant. More preferably, 3 to 45 parts of the blowing agent are added. Very preferably, 4 to 30 parts of the blowing agent are added, for example 5 to 25 parts of the blowing agent.

The use of water or a carboxylic acid or the use of a blowing agent provide the desired reduction in density of the polyurethane. When water or a carboxylic acid, particularly water, is used, the reaction exotherm is increased. With the use of water, the amount of urea linkages in the polyurethane foam is increased, which hardens the foam. In contrast, the use of a blowing agent moderates the temperature inside the reaction mixture and softens the foam. Nevertheless, the use of water is attractive but raises the requirements for stabilization of the polyurethane foam, which is generated during the reaction.

The polyurethane foam has a reduced density versus a polyurethane, which is obtained from the same reaction mixture except for a content of water or a carboxylic acid or a content of a blowing agent. The polyurethane foam has preferably a density between 5 to 500 kg/m³ at 20° C. and 101.3 kPa, more preferably between 10 to 300 kg/m³, very preferably 15 to 100 kg/m³ and most preferably 16 to 48 kg/m³. In case the polyurethane foam is a self-skinning foam (structural foam), the density is determined as the average density of the whole foam structure. Often, the density of a self-skinning polyurethane foam is 10 times higher than the density of a normal polyurethane foam.

The polyurethan can be a thermoplastic polyurethane. Thermoplastic polyurethanes are known in principle. Production is typically effected by reaction of the components (a) isocyanates and (b) isocyanate-reactive compounds and optionally (c) chain extenders optionally in the presence of at least one (d) catalyst and/or (e) customary auxiliaries and/or additives. The components (a) isocyanate, (b) isocyanate-reactive compounds, (c) chain extenders are also referred to individually or collectively as building block components.

Preferably employed organic isocyanates (a) include aliphatic, cycloaliphatic, araliphatic and/or aromatic isocyanates, more preferably tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate and/or 4,4′-, 2,4′- and 2,2′-dicyclohexylmethane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), 3,3′-dimethyl diphenyl diisocyanate, 1,2-diphenylethane diisocyanate and/or phenylene diisocyanate. It is particularly preferable to employ 4,4′-MDI.

In a further embodiment the present invention therefore relates to a composition as described hereinabove, wherein the thermoplastic polyurethane is based on diphenylmethane diisocyanate (MDI).

Employable isocyanate-reactive components (b) include in principle all suitable compounds known to those skilled in the art. According to the invention at least one diol is used as the isocyanate-reactive compound (b).

Any suitable diols may be employed in the context of the present invention, for example polyether diols or polyester diols or mixtures of two or more thereof.

Any suitable polyesterdiols may in principle be employed according to the invention, wherein in the context of the present invention the term polyesterdiol also comprises polycarbonate diols.

One embodiment of the present invention employs a polycarbonate diol or a polytetrahydrofuran polyol. Suitable polytetrahydrofuran polyols have a molecular weight for example in the range from 500 to 5000 g/mol, preferably 500 to 2000 g/mol, particularly preferably 800 to 1200 g/mol.

Suitable polycarbonate diols include for example polycarbonate diols based on alkanediols. Suitable polycarbonate diols are strictly difunctional OH-functional polycarbonate diols, preferably strictly difunctional OH-functional aliphatic polycarbonate diols. Suitable polycarbonate diols are for example based on 1,4-butanediol, 1,5-pentanediol or 1,6-hexanediol, in particular 1,4-butanediol, 1,5-pentanediol, 1,6-hexanediol, 3-methylpentane-(1,5)-diol or mixtures thereof, particularly preferably 1,4-butanediol, 1,5-pentanediol, 1,6-hexanediol or mixtures thereof. Preferably employed in the context of the present invention are polycarbonate diols based on 1,4-butanediol and 1,6-hexanediol, polycarbonate diols based on 1,5-pentanediol and 1,6-hexanediol, polycarbonate diols based on 1,6-hexanediol and mixtures of two or more of these polycarbonate diols.

The compositions according to the invention preferably comprise at least one thermoplastic polyurethane selected from the group consisting of thermoplastic polyurethanes based on at least one diisocyanate and at least one polycarbonate diol and thermoplastic polyurethanes based on at least one diisocyanate and polytetrahydrofuran polyol. Production of the polyurethanes present in the compositions according to the invention accordingly employs as component (b) at least one polycarbonate diol or a polytetrahydrofuran polyol.

In a further embodiment the present invention therefore relates to a composition as described hereinabove, wherein the thermoplastic polyurethane is selected from the group consisting of thermoplastic polyurethanes based on at least one diisocyanate and at least one polycarbonate diol and thermoplastic polyurethanes based on at least one diisocyanate and polytetrahydrofuran polyol. In a further embodiment the present invention therefore relates to a composition as described hereinabove, wherein the thermoplastic polyurethane is selected from the group consisting of thermoplastic polyurethanes based on at least one aromatic diisocyanate and at least one polycarbonate diol and thermoplastic polyurethanes based on at least one aromatic diisocyanate and polytetrahydrofuran polyol.

It is possible that the composition is a part of a shaped article or the complete shaped article. Preferably, the composition is the complete shaped article. Examples for the shaped article are:
1) Floating devices for marine applications.
2) Automotive applications, in particular bumpers, dashboards, rear and front linings, moldings parts under the hood, hat shelf, trunk linings, interior linings, air bag covers, instrument panel, exterior linings, upholstery, interior and exterior trims, door πανελσ, seat backing, exterior panels, cladding, pillar covers, chassis parts, convertible tops, front end module, pressed/stamped parts, side impact protection, sound deadener/insulator and sunroof.
3) Plane furnishings, Railway furnishings.
4) Devices for architecture and design, acoustic quietized systems, shelters.
5) Jacketing for other materials such as steel or textiles, for example cable-jacketing.
6) Electric appliances, in particular washing machines, tumblers, ovens (microwave oven), dish-washers, mixers.
7) Rotor blades, ventilators and windmill vanes, swimming pool covers, pool liners, pond liners, closets, wardrobes, dividing walls, slat walls, folding walls, roofs, shutters (e.g. roller shutters), sealings.
8) Packing and wrapping, isolated bottles.
9) Furniture in general, foamed articles (cushions, mattresses, impact absorbers), foams, sponges, dish clothes, mats.
10) Shoes, soles, insoles, spats, adhesives, structural adhesives, couches.

The composition may preferably comprise further additives, such as antioxidants, metal deactivators, phosphites and phosphonates, hydroxylamines and amine N-oxides, nitrones, thiosynergists, peroxide scavengers, basic co-stabilizers, nucleating agents, fillers and reinforcing agents, benzofuranones and indolinones, flame retardants, or other additives, for example plasticisers, lubricants, emulsifiers, pigments, rheology additives, catalysts, flow-control agents, optical brighteners, flameproofing agents, antistatic agents and blowing agents, heat stabilizers, anti-fog agents, anti-mist agents, anti-blocking additives, slip agents, anti-scratch agents. The further additives may for example be selected from the following list:
1. Antioxidants
1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethyl-phenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, 2,4-dimethyl-6-(1′-methyl-1′-tetradecyl-methyl)-phenol and mixtures thereof.
1.2. Alkylthiomethylphenols, for example 2,4-dioctylthiomethyl-6-tert-butylphenol, 2,4-dioctylthio-methyl-6-methylphenol, 2,4-dioctylthiomethyl-6-ethylphenol, 2,6-di-dodecyl-thiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octadecyl-oxy-phenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E), vitamin E acetate. Especially preferred is the addition of 2,5,7,8-tetramethyl-2-[4,8,12-trimethyltridecyl]-chroman-6-ol], which is a commercially available vitamin E (e.g. Irganox E 201™).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(xx-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl) dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl) propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl) pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetra-methylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexa-hydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid, (3,5-ditert-butyl-4-hydroxy-phenyl)methylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, for example with methanol, ethanol, n-octanol, i-octanol, a mixture of linear and branched C₇-C₉-alkanol, octadecanol, a mixture of linear and branched C₁₃-C₁₅-alkanol, 1,6-hexanediol, 1,9-nonanediol, ethylene glycol, 1,2-propanediol, neopentyl glycol, thiodiethylene glycol, diethylene glycol, triethylene glycol, tetraethylene glycol, oligoethylene glycol with 3 to 15 ethylene glycol units, pentaerythritol, tris(hydroxyethyl)isocyanurate, N,N′-bis-(hydroxy-ethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane. Preferred are esters of β-(3,5-di-tert-butyl-4-hydroxyphenyl)propionic acid, especially with octadecanol, such as the addition of Octadecyl-3-(3,5-di-tert.butyl-4-hydroxyphenyl)-propionate, which is a commercially available as e.g. Irganox 1076™.
1.14. Esters of β-(5-tert-butyl-4-hydroxy-3-methylphenyl)propionic acid with mono- or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]undecane.
1.15. Esters of β-(3,5-dicyclohexyl-4-hydroxyphenyl)propionic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid, for example N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenyl-propionyl)hydrazide, N,N′-bis[2-(3-[3,5-di-tert-butyl-4-hydroxyphenyl]propionyloxy)ethyl]oxamide (Naugard XL-1 (RTM), supplied by SI Group).
1.18. Ascorbic acid (vitamin C)
1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclo-hexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, nonylated diphenylamine, octylated diphenylamine, for example p,p′-di-tert-octyldiphenylamine, 4-n-butylaminophenol, 4-butyrylaminophenol, 4-nonanoylaminophenol, 4-do-decanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]-ethane, 1,2-bis(phenylamino) propane, (o-tolyl) biguanide, bis[4-(1′,3′-dimethylbutyl)-phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines or a mixture of mono- and dialkylated tert-octylphenothiazines, N-allylphenothiazine, N,N,N′,N′-tetraphenyl-1,4-diaminobut-2-ene, N-[(1,1,3,3-tetramethylbutyl)phenyl]-1-napthalenamine] (commercially available as Irganox L06™), nonylated diphenylamine.

Alternatively, or in addition, a commercially available mixture of additives may be used as well, of which especially preferred is Irganox 5057 ™, which is obtained by the reaction of diphenylamine with diisobutylene, and which comprises
(A)₅₀₅₇ diphenylamine;
(B)₅₀₅₇ 4-tert-butyldiphenylamine;
(C)₅₀₅₇ compounds of the group
   i) 4-tert-octyldiphenylamine,
   ii) 4,4′-di-tert-butyldiphenylamine,
   iii) 2,4,4′-tris-tert-butyldiphenylamine,
(D)₅₀₅₇ compounds of the group
   i) 4-tert-butyl-4′-tert-octyldiphenylamine,
   ii) o,o′, m,m′, or p,p′-di-tert-octyldiphenylamine,
   iii) 2,4-di-tert-butyl-4′-tert-octyldiphenylamine,
(E)₅₀₅₇ compounds of the group
   i) 4,4′-di-tert-octyldiphenylamine,
   ii) 2,4-di-tert-octyl-4′-tert-butyldiphenylamine, and
wherein not more than 5% by weight of component (A)₅₀₅₇, 8 to 15% by weight of component (B)₅₀₅₇, 24 to 32% by weight of component (C)₅₀₅₇, 23 to 34% by weight of component (D)₅₀₅₇ and 21 to 34% by weight of component (E)₅₀₅₇ are present.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)-oxalyl dihydrazide, N,N′-bis(salicyloyl)thiopropionyl dihydrazide.
4. Phosphites and phosphonates such as Tris alkyl (C₁₂-C₁₅) phosphite, Triisodecyl phosphite, Triisotridecyl phosphite, Dioleyl Hydrogen phosphite, Triisooctyl Phosphite, Heptakis (dipropyleneglycol) Triphosphite, Trilauryl Trithio Phosphite, Tris (Dipropyleneglycol) Phosphite, Dimethyl hydrogen phosphite, Dibutyl hydrogen phosphite, Dilauryl hydrogen phosphite, Tri-C12-C14-phosphite or Bis(2-ethylhexyl) hydrogen phosphite. Other phosphites and phosphonates, which are for instance liquid ones such as Di-n-octyl hydrogen phosphite or Di-isooctyl hydrogen phosphite, or for example triphenyl phosphite, tris(nonylphenyl) phosphite, Phenyldiisodecyl phosphite, Diphenylisodecyl phosphite, [Triphenyl phosphite, polymer with 1,4-cyclohexanedimethanol and polypropylene glycol, C10-16 alkyl esters (CAS Reg. No. 1821217-71-3)]. Further optional phosphites or phosphonates additives are for instance Alkyl (C12-C15) bisphenol A phosphite, Alkyl (C10) bisphenol A phosphite, Poly (dipropyleneglycol)phenyl phosphite, Tris (tridecyl) phosphite, Diphenyl phosphite, Dodecyl nonylphenol phosphite blend, Phenyl Neopentylene Glycol Phosphite, Poly 4,4′ Isopropylidenediphenol-C10 Alcohol Phosphite, Poly 4,4′ Isopropylidenediphenol-C12-15 Alcohol Phosphite, diphenylalkyl phosphites, phenyldialkyl phosphites, C₁₂-C₁₈ alkyl bis[4-(1-methyl-1-phenyl-ethyl)phenyl] phosphite, C₁₂-C₁₈ alkenyl bis[4-(1-methyl-1-phenyl-ethyl)phenyl] phosphite, bis[4-(1-methyl-1-phenyl-ethyl)phenyl][(E)-octadec-9-enyl] phosphite, decyl bis[4-(1-methyl-1-phenyl-ethyl)phenyl] phosphite, didecyl [4-(1-methyl-1-phenyl-ethyl)phenyl] phosphite, [4-(1-methyl-1-phenyl-ethyl)phenyl] bis[(E)-octadec-9-enyl] phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,4-di-cumylphenyl) pentaerythritol diphosphite, bis(2,6-di-tert-butyl-4-methylphenyl) pentaerythritol diphosphite, diisodecyloxypentaerythritol diphosphite, bis(2,4-di-tert-butyl-6-methylphenyl) pentaerythritol diphosphite, bis(2,4,6-tris(tert-butylphenyl) pentaerythritol diphosphite, [2-tert-butyl-4-[1-[5-tert-butyl-4-di(tridecoxy) phosphanyloxy-2-methyl-phenyl]butyl]-5-methyl-phenyl]ditridecyl phosphite, tristearyl sorbitol triphosphite, a mixture of at least two different tris(mono-C₁-C₈-alkyl)phenyl phosphites such as for example mentioned in U.S. Pat. No. 7,468,410 B2 as products of examples 1 and 2, a mixture of phosphites comprising at least two different tris(amylphenyl) phosphites such as for example mentioned in U.S. Pat. No. 8,008,383 B2 as mixtures 14, 15, 16, 17, 18, 19, 20, 21, 22, 23, 24, 25 and 26, a mixture of a least four different phosphites comprising tris[4-(1,1-dimethylpropyl)phenyl] phosphite, [2,4-bis(1,1-dimethylpropyl)phenyl] bis[4-(1,1-dimethylpropyl)phenyl] phosphite, bis[2,4-bis(1,1-dimethylpropyl)phenyl][4-(1,1-dimethylpropyl)phenyl] phosphite and tris[2,4-bis(1,1-dimethylpropyl)phenyl] phosphite, a mixture of phosphites comprising at least two different tris(butylphenyl) phosphites such as for example mentioned in U.S. Pat. No. 8,008,383 B2 as mixtures 34, 35, 36, 37, 38, 39 and 40, an oxyalkylene-bridged bis-(di-C₆-aryl) diphosphite or an oligomeric phosphite obtainable by condensation under removal of hydrogen chloride of (i) a trichlorophosphane, with (ii) a dihydroxyalkane interrupted by one or more oxygen atoms and with (iii) a mono-hydroxy-C₆-arene such as for example mentioned in U.S. Pat. No. 8,304,477 B2 as products of examples 1, 2, 3, 4, 5, 6, 7, 8, 9, 10, 11, 12, 13, 14, 15, 16 and 17, a polymeric phosphite obtainable by transesterification under removal of phenol of (i)triphenyl phosphite with (ii) a dihydroxyalkane optionally interrupted by one or more oxygen atoms and/or a bis-(hydroxyalkyl)(alkyl)amine and with (iii) a mono-hydroxyalkane optionally interrupted by one or more oxygen atoms such as for example mentioned in U.S. Pat. No. 8,563,637 B2 as products of examples 1, 2, 3, 4, 5, 6, 7, 8, 9, 10 and 11, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylbis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocine, 1,3,7,9-tetra-tert-butyl-11-octoxy-5H-benzo[d][1,3,2]benzodioxaphosphocine, 2,2′,2″-nitrilo [triethyltris(3,3′,5,5′-tetra-tert-butyl-1,1′-biphenyl-2,2′-diyl)phosphite], phosphorous acid, triphenyl ester, polymer with α-hydro-ω-hydroxypoly[oxy(methyl-1,2-ethanediyl)], C10-16-alkyl esters (CAS Reg. No. [1227937-46-3]), 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, mixed 2,4-bis(1,1-dimethylpropyl)phenyl and 4-(1,1-dimethylpropyl)phenyl triesters (CAS Reg. No. [939402-02-5]).

The following phosphites are especially preferred:

Tris(2,4-di-tert-butylphenyl) phosphite (Irgafos®168, Ciba Specialty Chemicals Inc.), tris(nonylphenyl) phosphite,

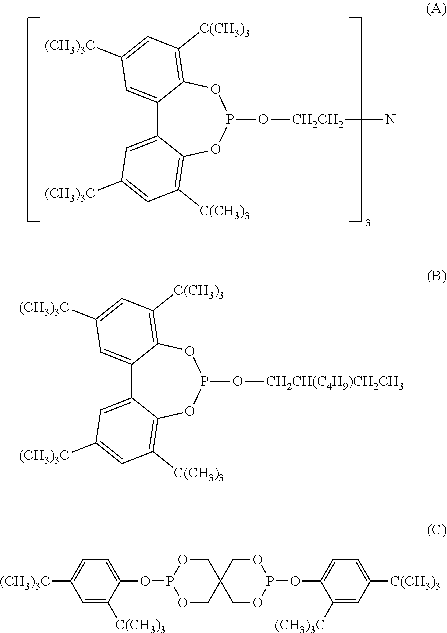

5. Hydroxylamines and amine N-oxides, for example N,N-dibenzylhydroxylamine, N,N-di-ethylhydroxylamine, N,N-dioctylhydroxylamine, N,N-dilaurylhydroxylamine, N, N-ditetradecyl-hydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N, N-dialkylhydroxylamine derived from hydrogenated tallow amine, bis(hydrogenated palm-oil alkyl) hydroxyamine, N,N-bis-(hydrogenated rape-oil alkyl)-N-methyl-amine N-oxide or trialkylamine N-oxide.
6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine (optionally from vegetable source).
7. Thiosynergists, for example dilauryl thiodipropionate, dimistryl thiodipropionate, distearyl thiodipropionate and pentaerythritol tetrakis-[3-(n-lauryl)-propionic acid ester].
8. Peroxide scavengers, for example esters of a-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(b-dodecylmercapto)propionate.
10. Polyamide stabilizers, for example copper salts in combination with iodides and/or phosphorus compounds and salts of divalent manganese.
11. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate, zeolithes, hydrotalcites, hydrocaluminates, zinc oxide.
12. Nucleating agents, for example inorganic substances, such as talcum, metal oxides, such as titanium dioxide or magnesium oxide, phosphates including phosphate salts such as 2,2′-methylene-bis(4,6-di-tert-butylphenol) phosphate sodium salt, 2,2′-methylene-bis(4,6-di-tert-butylphenol) phosphate aluminium salt or 2,2′-methylene-bis(4,6-di-tert-butylphenol) phosphate lithium salt, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate, 1,2-cyclohexane dicarboxylic acid calcium salt, bicyclo[2.2.1]heptane-2,3-dicarboxylic acid disodium salt; polymeric compounds, such as ionic copolymers (ionomers), triamino benzene derivatives such as 1,3,5-tris[2,2-dimethylpropionylamine]benzene, zinc glycerolate and nonytol derivatives. Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.
13. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.
14. Other additives, for example plasticisers, lubricants, emulsifiers, pigments, rheology additives, catalysts, flow-control agents, optical brighteners, flameproofing agents, antistatic agents and blowing agents, heat stabilizers, anti-fog agents, anti-mist agents, anti-blocking additives, slip agents, anti-scratch agents.
15. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839 or EP-A-0591102, WO2015/121445, WO2017/025431, or 5,7-di-tert-butyl-3-(4-hydroxyphenyl)-3H-benzofuran-2-one, 5,7-di-tert-butyl-3-[4-(2-hydroxyethoxy)phenyl]-3H-benzofuran-2-one, 5,7-di-tert-butyl-3-[4-[2-[2-[2-[2-(2-hydroxyethoxy)ethoxy]ethoxy]ethoxy]ethoxy]phenyl]-3H-benzofuran-2-one, 3-[4-(2-acetoxy-ethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]-phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetoxy-4-(1,1,3,3-tetramethyl-butyl)-phenyl)-5-(1,1,3,3-tetramethyl-butyl)-benzofuran-2-one, [6-[6-[6-[2-[4-(5,7-di-tert-butyl-2-oxo-3H-benzofuran-3-yl) phenoxy]ethoxy]-6-oxo-hexoxy]-6-oxo-hexoxy]-6-oxo-hexyl] 6-hydroxyhexan-oate, [4-tert-butyl-2-(5-tert-butyl-2-oxo-3H-benzofuran-3-yl)phenyl] benzoate, [4-tert-butyl-2-(5-tert-butyl-2-oxo-3H-benzofuran-3-yl)phenyl] 3,5-di-tert-butyl-4-hydroxy-benzoate and [4-tert-butyl-2-(5-tert-butyl-2-oxo-3H-benzofuran-3-yl)phenyl] 3-(3,5-di-tert-butyl-4-hydroxy-phenyl) propanoate.
16. Flame retardants
16.1. Phosphorus containing flame retardants including reactive phosphorous containing flame retardants, for example tetraphenyl resorcinol diphosphite (Fyrolflex RDP, RTM, Akzo Nobel), tetrakis(hydroxymethyl)phosphonium sulphide, triphenyl phosphate, diethyl-N,N-bis(2-hy-droxyethyl)-aminomethyl phosphonate, hydroxyalkyl esters of phosphorus acids, alkylphosphate oligomers, ammonium polyphosphate (APP), resorcinol diphosphate oligomer (RDP), phosphazene flame retardants or ethylenediamine diphosphate (EDAP).
16.2. Nitrogen containing flame retardants, for example melamine-based flame retardants, isocyanurates, polyisocyanurate, esters of isocyanuric acid, like tris-(2-hydroxyethyl) isocyanurate, tris(hydroxymethyl)isocyanurate, tris(3-hydroxy-n-propyl)isocyanurate, triglycidyl isocyanurate, melamine cyanurate, melamine borate, melamine phosphate, melamine pyrophosphate, melamine polyphosphate, melamine ammonium polyphosphate, melamine ammonium pyrophosphate, dimelamine phosphate, dimelamine pyrophosphate, benzoguanamine, allantoin, glycoluril, urea cyanurate, a condensation product of melamine from the series melem, melam, melon and/or a higher condensed compound or a reaction product of melamine with phosphoric acid or a mixture thereof.
16.3. Organohalogen flame retardants, for example polybrominated diphenyl oxide, decabromodiphenyl oxide (DBDPO), tris[3-bromo-2,2-bis(bromomethyl)propyl] phosphate (PB 370, (RTM, FMC Corp.)), tris(2,3-dibromopropyl) phosphate, chloroalkyl phosphate esters such as tris(chloropropyl) phosphate, tris(2,3-dichloropropyl) phosphate, tris(1,3-dichloro-2-propyl) phosphate (Fyrol FR 2 (RTM ICL)), oligomeric chloroalkyl phosphate, chlorendic acid, tetrachlorophthalic acid, tetrabromophthalic acid, poly-b-chloroethyl triphosphonate mixture, tetrabromobisphenol A-bis(2,3-dibromopropyl ether) (PE68), brominated epoxy resin, brominated aryl esters, ethylene-bis(tetrabromophthalimide) (Saytex BT-93 (RTM, Albemarle)), bis(hexachlorocyclopentadieno)cyclooctane (Declorane Plus (RTM, Oxychem)), chlorinated paraffins, octabromodiphenyl ether, hexachlorocyclopentadiene derivatives, 1,2-bis(tribromophenoxy) ethane (FF680), tetrabromobisphenol A (Saytex RB100 (RTM, Albemarle)), ethylene bis-(dibromonorbornanedicarboximide) (Saytex BN-451 (RTM, Albemarle)), bis-(hexachlorocycloentadeno)cyclooctane, PTFE, tris(2,3-dibromopropyl) isocyanurate or ethylene-bis-tetrabromophthalimide. Some of the halogenated flame retardants mentioned above are routinely combined with an inorganic oxide synergist. Some of the halogentated flame retardants mentioned above can be used in combination with triaryl phosphates (such as the propylated, butylated triphenyl phosphates) and the like and/or with oligomeric aryl phosphates (such as resorcinol bis(diphenyl phosphate), bisphenol A bis(diphenyl phosphate), neopentylglycol bis(diphenyl phosphate)) and the like.
16.4. Inorganic flame retardants, for example aluminium trihydroxide (ATH), boehmite (AlOOH), magnesium dihydroxide (MDH), zinc borates, CaCO₃, organically modified layered silicates, organically modified layered double hydroxides, and mixtures thereof. In regard to the synergistic combination with halogenated flame retardants, the most common inorganic oxide synergists are zinc oxides, antimony oxides like Sb₂O₃ or Sb₂O₅ or boron compounds.

The incorporation or contacting of the phenyl triazine of formula (A), the hindered amine light stabilizer and the UV absorber and optionally the further additives in the polyurethane can be achieved by conventional methods, such as adding the modifier blend or its single components to the polymeric material. The components can be added to the polyurethane in the form of a liquid, a powder, granule or a masterbatch. The phenyl triazine of formula (A), the UV absorber and the hindered amine light stabilizer and optionally further additives may be added to the polyurethane either individually or mixed with one another. It is preferred that the phenyl triazine of formula (A), the UV absorber and the hindered amine light stabilizer are added together, such as in the form of a masterbatch.

### EXAMPLES

Unless otherwise indicated, all parts and percentages are by weight. Weight percent (wt %), if not otherwise indicated, is based on an entire composition free of any volatiles.

### UV Absorbers:

UV 1: Ethanediamide, N-(2-ethoxyphenyl)-N′-(2-ethylphenyl)
UV 2: N′-(4-Ethoxycarbonylphenyl)-N-methyl-N-phenylformamidine
UV 3: 2 Phenol, 2-(2H-benzotriazol-2-yl)-4,6-bis(1-methyl-1-phenylethyl)
UV 4/5: Mixture of α-[3-[3-(2H-Benzotriazol-2-yl)-5-(1,1-dimethylethyl)-4-hydroxyphenyl]-1-oxopropyl]-ω-hydroxypoly(oxy-1,2-ethanediyl) and α-[3-[3-(2H-Benzotriazol-2-yl)-5-(1,1-dimethylethyl)-4-hydroxyphenyl]-1-oxopropyl]-ω-[3-[3-(2H-benzotriazol-2-yl)-5-(1,1-dimethylethyl)-4-hydroxy-phenyl]-1-oxopropoxy] poly(oxy-1,2-ethanediyl), weight ratio about 3:1.
UV 6: 1,3-bis-((2′-cyano-3′,3′-diphenylacryloyl)oxy)-2,2-bis-(((2′-cyano-3′,3′-diphenylacryloyl)oxy)methyl)-propane
UV 7: 2-Ethylhexyl 2-cyano-3,3-diphenylacrylate

### Hindered Amine Light Stabilizers:

HALS 1: Dimethyl succinate-4-hydroxy-2,2,6,6-tetramethyl-1-piperidineethanol copolymer
HALS 2/3: Reaction mass of bis(1,2,2,6,6-pentamethyl-4-piperidyl) sebacate and methyl 1,2,2,6,6-pentamethyl-4-piperidyl sebacate, comprises a mixture of Bis(1,2,2,6,6-pentamethyl-4-piperidyl) decanedioate and Methyl 1,2,2,6,6-pentamethyl-4-piperidinyl sebacate
HALS 4: tertiary HALS, liquid, prepared according to Example 1 of WO2009/068492.

### Phenyl Triazine:

HPT 1: Phenol, 2-[4,6-bis([1,1′-biphenyl]-4-yl)-1,3,5-triazin-2-yl]-5-[(ethylhexyl)oxy
HPT 2: phenol, 2-(4,6-Diphenyl-1,3,5-triazin-2-yl)-5-hexyloxy
HPT 3:2-[4,6-Bis(2,4-dimethylphenyl)-1,3,5-triazin-2-yl]-5-(octyloxy)phenol
HPT 4:2-[4,6-Bis(2,4-dimethylphenyl)-1,3,5-triazin-2-yl]-5-[3-[(2-ethylhexyl)oxy]-2-hydroxypropoxy]phenol
HPT 5: 2,2′-[6-(2,4-Dibutoxyphenyl)-1,3,5-triazine-2,4-diyl]bis[5-butoxyphenol
HPT 6: 2,2′,2″-(1,3,5-Triazine-2,4,6-triyl)tris[5-(hexyloxy)-6-methylphenol
HPT 7: 5-[(2-ethylhexyl)oxy]-2-(4-{4-[(2-ethylhexyl)oxy]-2-hydroxyphenyl}-6-(4-methoxyphenyl)-1,3,5-triazin-2-yl)phenol

### Example 1

### Manufacture of Thermoplastic Polyurethane Test Panels (Plaques)

Thermoplastic Polyurethane (Aromatic TPU) was used (polyester type, extrusion and injection molding grade, Shore A 85).

### Compounding

2.5 kg of pellets were grounded in a cryogenic mill and dried under vacuum at 80° C. until water content was inferior to 0.05%. The TPU powder was mixed to homogeneity in a tumbler mixer with 2% of stabilizers compositions as reported in Tables 1 and 2 below. These blends were then immediately extruded in a twin-screw extruder Berstorff ZE25A×47D at a temperature of at most 210° C. The obtained granulates were dried again under dry air at 80° C. until the water content was inferior to 0.03%.

### Injection Molding

Test panels (plaques) of the size 64 mm×44 mm×2 mm were molded from the obtained granulates by means of an injection-molding machine (Engel® e-mac 100) at a temperature of at most 210° C. (mold temperature: 40° C.).

### Weathering Resistance Test

In order to assess the light stability performance achieved with the different light stabilizers packages, the produced plaques were exposed to artificial accelerated weathering according to the methods ASTM G155-dry (Xenon lamp, using the same conditions as for ASTM G 155, cycle 1, but without rain cycles) and the method SAE J 2412 (Xenon lamp).

### Measurement of Color

The discoloration at intermediate exposure time and at the end of exposure were measured with a spectrophotometer CM-3700 d (Minolta). Yellowness Index, without unit, according to ASTM E313. Delta E, in CIELAB units, taken as the square root of the squares of the differences in the L*, a* and b* CIELAB color coordinates at the time of recall minus time zero, as defined in ISO 11664-4, was measured to provide information on the change in color of the plaques upon exposure in reference to the initial value. The obtained results are reported in Tables 1 and 2.

TABLE 1
TPU plaques discoloration after 1414 hours exposure to accelerated
weathering according to the method ASTM G 155-dry.

| | | Yellow- | |
|---|---|---|---|
| | Light stabilizers compositions | ness | Delta |
| Example | (% parts based on 100 parts TPU) | Index | E |
| 1-1 ^{a)} | 1.2% UV 1 + 0.8% HALS 1 | 42.0 | 22.5 |
| 1-2 ^{b)} | 1.0% UV 1 + 0.8% HALS 1 + 0.2% HPT 3 | 39.8 | 20.6 |
| 1-3 ^{b)} | 1.1% UV 1 + 0.8% HALS 1 + 0.1% HPT 4 | 38.6 | 20.1 |
| 1-4 ^{b)} | 1.0% UV 1 + 0.8% HALS 1 + 0.2% HPT 4 | 38.9 | 19.6 |
| 1-5 ^{a)} | 1.0% UV 2 + 1.0% HALS 2/3 | 49.1 | 26.0 |
| 1-6 ^{b)} | 0.9% UV 2 + 1.0% HALS 2/3 + 0.1% | 48.1 | 25.2 |
| | HPT 4 | | |
| 1-7 ^{b)} | 0.8% UV 2 + 1.0% HALS 2/3 + 0.2% | 48.5 | 25.2 |
| | HPT 4 | | |
| 1-8 ^{a)} | 1.0% UV 6 + 1.0% HALS 1 | 46.0 | 24.2 |
| 1-9 ^{b)} | 0.8% UV 6 + 1.0% HALS 1 + 0.2% HPT 4 | 44.4 | 23.1 |

^{a)} Comparative data
^{b)} According to the invention

The above results showed that the inventive Examples gave TPU plaques with improved light stability and lower discoloration upon light-exposure compared to the Comparative Examples.

TABLE 2
TPU plaques discoloration after 750 hours exposure to accelerated
weathering according to the method SAE J 2412.

| | Light stabilizers compositions | |
|---|---|---|
| Examples | (% parts based on 100 parts TPU) | Delta E |
| 2-1 ^{a)} | 1.0% UV 7 + 1.0% HALS 4 | 35.0 |
| 2-2 ^{b)} | 0.67% UV 7 + 1.0% HALS 4 + 0.33% HPT 7 | 23.7 |
| 2-3 ^{b)} | 0.67% UV 7 + 1.0% HALS 4 + 0.33% HPT 5 | 24.9 |
| 2-4 ^{a)} | 1.0% UV 4/5 + 1.0% HALS 4 | 24.7 |
| 2-5 ^{b)} | 0.67% UV 4/5 + 1.0% HALS 4 + 0.33% HPT 2 | 22.3 |

^{a)} Comparative data
^{b)} According to the invention

The above results showed that the inventive Examples gave TPU plaques with improved light stability and lower discoloration upon light-exposure compared to the Comparative Examples.

### Example 2

### Manufacture of Thermoplastic Polyurethane Test Panels (Plaques)

Thermoplastic Polyurethane (Aromatic TPU) has been used (polyether type, extrusion and injection molding grade, Shore A 87).

### Compounding

2.5 kg of pellets were ground in a cryogenic mill and dried under vacuum at 80° C. until water content was inferior to 0.05%. The TPU powder was mixed to homogeneity in a tumbler mixer with 2% of stabilizers compositions as reported in Table 3 below. These blends were then immediately extruded in a twin-screw extruder Berstorff ZE25A×47D at a temperature of at most 210° C. The obtained granulates were dried again under dry air at 80° C. until the water content was inferior to 0.03%.

### Injection Molding

Test panels (plaques) of the size 64 mm×44 mm×2 mm were molded from the obtained granulates by means of an injection-molding machine (Engel® e-mac 100) at a temperature of at most 210° C. (mold temperature: 30° C.).

### Weathering Resistance Test

In order to assess the light stability performance achieved with the different light stabilizers packages, the produced plaques were exposed to artificial accelerated weathering according to the method ISO 105-B06 (Xenon lamp).

### Measurement of Color

The discoloration at intermediate exposure time and at the end of exposure were measured with a spectrophotometer CM-3700 d (Minolta). Delta E, in CIELAB units, taken as the square root of the squares of the differences in the L*, a* and b* CIELAB color coordinates at the time of recall minus time zero, as defined in ISO 11664-4, was measured to provide information on the change in color of the plaques upon exposure in reference to the initial value. The obtained results are reported in Table 3.

TABLE 3
TPU plaques discoloration after 1000 hours exposure to accelerated
weathering according to the method ISO 105-B06.

| | Light stabilizers compositions | |
|---|---|---|
| Examples | (% parts based on 100 parts TPU) | Delta E |
| 3-1 ^{a)} | 1.0% UV 3 + 1.0% HALS 1 | 19.4 |
| 3-2 ^{b)} | 0.8% UV 3 + 1.0% HALS 1 + 0.2% HPT 2 | 18.9 |
| 3-3 ^{b)} | 0.8% UV 3 + 1.0% HALS 1 + 0.2% HPT 1 | 17.4 |
| 3-4 ^{b)} | 0.9% UV 3 + 1.0% HALS 1 + 0.1% HPT 1 | 18.2 |
| 3-5 ^{b)} | 0.8% UV 3 + 1.0% HALS 1 + 0.2% HPT 5 | 19.4 |
| 3-6 ^{b)} | 0.8% UV 3 + 1.0% HALS 1 + 0.2% HPT 6 | 18.8 |

^{a)} Comparative data
^{b)} According to the invention

The above results showed that the inventive Examples gave TPU plaques with improved light stability and lower discoloration upon light-exposure compared to the Comparative Example.

### Example 3

### Manufacture of Thermoplastic Polyurethane Test Panels (Plaques)

Thermoplastic Polyurethane (Aromatic TPU) has been used (polyether type, extrusion and injection molding grade, Shore A 87).

### Compounding

2.5 kg of pellets were ground in a cryogenic mill and dried under vacuum at 80° C. until water content was inferior to 0.05%. The TPU powder was mixed to homogeneity in a tumbler mixer with 2% of stabilizers compositions as reported in Table 4 below. These blends were then immediately extruded in a twin-screw extruder Berstorff ZE25A×47D at a temperature of at most 210° C. The obtained granulates were dried again under dry air at 80° C. until the water content was inferior to 0.03%.

### Injection Molding

Test panels (plaques) of the size 64 mm×44 mm×2 mm were molded from the obtained granulates by means of an injection-molding machine (Engel® e-mac 100) at a temperature of at most 210° C. (mold temperature: 30° C.).

### Weathering Resistance Test

In order to assess the light stability performance achieved with the different light stabilizers packages, the produced plaques were exposed to artificial accelerated weathering according to the method Adidas FT 11 (neon light).

### Measurement of Color

The discoloration at intermediate exposure time and at the end of exposure were measured with a spectrophotometer CM-3700 d (Minolta). Yellowness Index, without unit, according to ASTM E₃₁₃. Delta E, in CIELAB units, taken as the square root of the squares of the differences in the L*, a* and b* CIELAB color coordinates at the time of recall minus time zero, as defined in ISO 11664-4, was measured to provide information on the change in color of the plaques upon exposure in reference to the initial value.

The obtained results are reported in Table 4.

TABLE 4
TPU plaques discoloration after 8 hours exposure to accelerated
weathering according to the method Adidas FT 11.

| | | Yellow- | |
|---|---|---|---|
| | Light stabilizers compositions | ness | Delta |
| Examples | (% parts based on 100 parts TPU) | Index | E |
| 4-1 ^{a)} | 1.2% UV 1 + 0.8% HALS 1 | 13.5 | 4.7 |
| 4-2 ^{b)} | 1.1% UV 1 + 0.8% HALS 1 + 0.1% HPT 4 | 12.2 | 3.4 |
| 4-3 ^{b)} | 1.0% UV 1 + 0.8% HALS 1 + 0.2% HPT 3 | 9.8 | 1.9 |
| 4-3 ^{b)} | 1.0% UV 1 + 0.8% HALS 1 + 0.2% HPT 3 | 9.8 | 1.9 |
| 4-4 ^{a)} | 1.0% UV 6 + 1.0% HALS 1 | 13.5 | 3.8 |
| 4-5 ^{b)} | 0.8% UV 6 + 1.0% HALS 1 + 0.2% HPT 4 | 12.6 | 3.2 |

^{a)} Comparative data
^{b)} According to the invention

1. A composition comprising
a polyurethane;
at least one UV absorber;
at least one hindered amine light stabilizer; and
at least one phenyl triazine of formula (A) 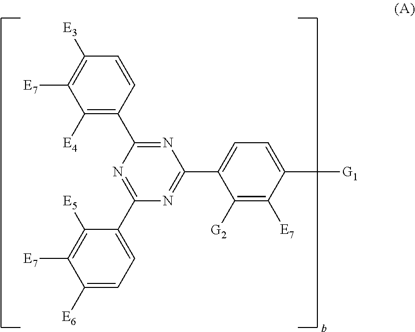
wherein
G₁ is —O-E₁, phenyl, or phenyl substituted by 1, 2 or 3 C₁-C₄alkyl,
G₂ is —O-E₂ when G₁ is —O-E₁, or H when G₁ is not —O-E₁,
E₁ is hydrogen, C₁-C₁₈ alkyl, C₃-C₅₀ alkyl interrupted by oxygen, C₃-C₅₀ hydroxyalkyl interrupted by oxygen, or a group of formula P 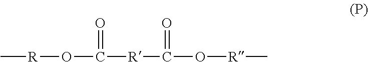
wherein, R, R′ and R″ independently of one another are C₁-C₁₈ alkylene,
b is an integer in the range of 1 to 3, or a group of formula Q 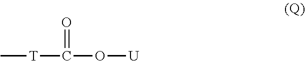
wherein T and U independently of one another are linear or branched C₁-C₁₈ alkyl,
wherein b is 1 when G₁ is phenyl, or phenyl substituted by 1, 2 or 3 C₁-C₄ alkyl,
E₂, E₃, E₄, E₅, and E₆ independently of one another are hydrogen, hydroxy, C₁-C₁₈ alkyl, phenyl
or phenyl substituted by 1, 2 or 3 C₁-C₄alkyl, or a group of formula Q 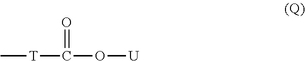
wherein, T and U independently of one another are linear or branched C₁-C₁₈ alkyl, and
E₇ independently of one another are hydrogen, or C₁-C₁₈ alkyl.

2. The composition according to claim 1, wherein the weight ratio of the sum of the at least one UV absorber and the at least one hindered amine light stabilizer to the at least one phenyl triazine of formula (A) is from 30:1 to 4:1.

3. The composition according to claim 1, wherein the weight ratio of the at least one UV absorber to the at least one hindered amine light stabilizer is from 3:1 to 1:3.

4. The composition according to claim 1, wherein the at least one phenyl triazine of formula (A) is selected from formulae (A1), (A2), (A3), (A4), (A5), (A6) and/or (A7);

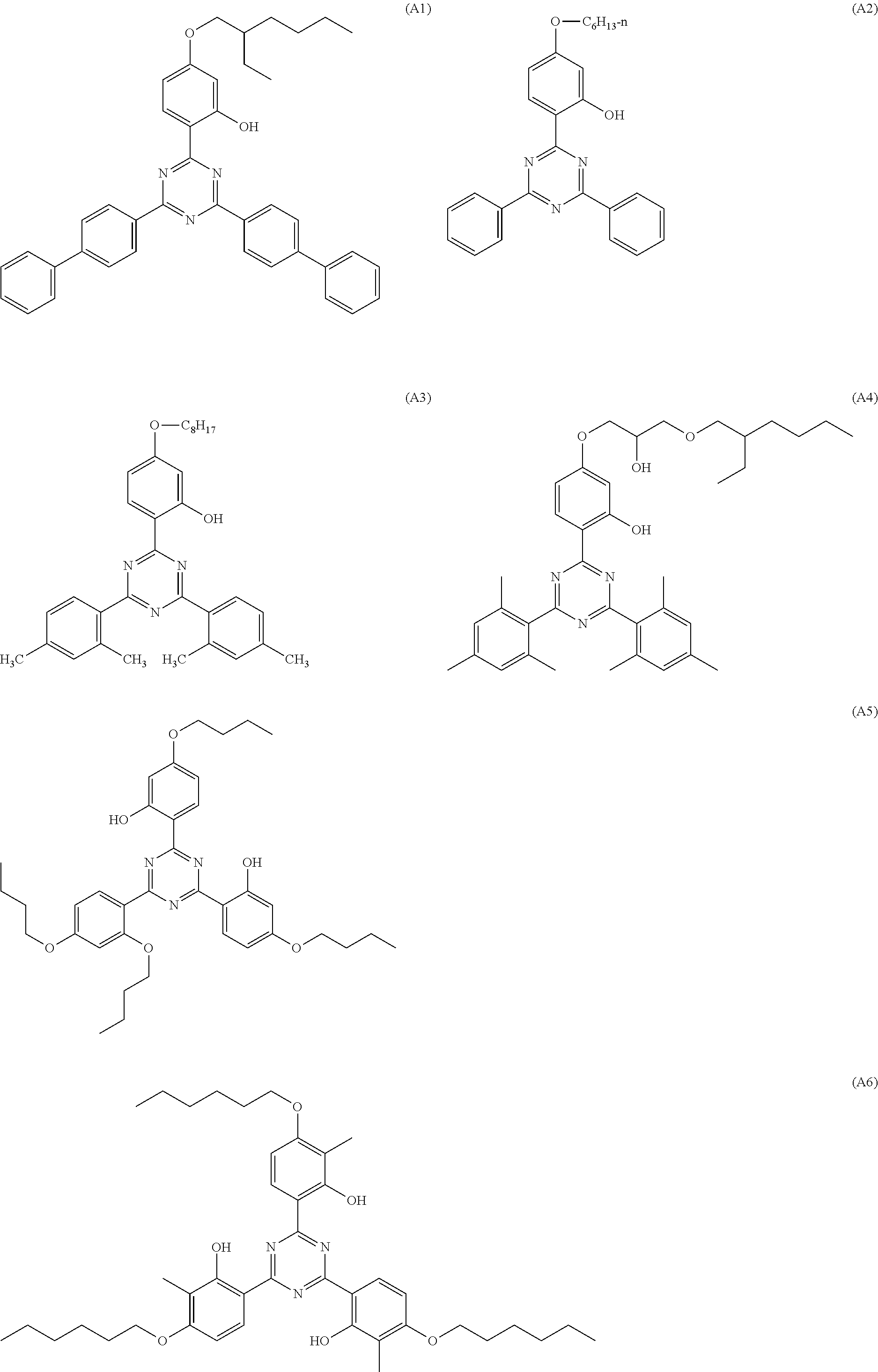

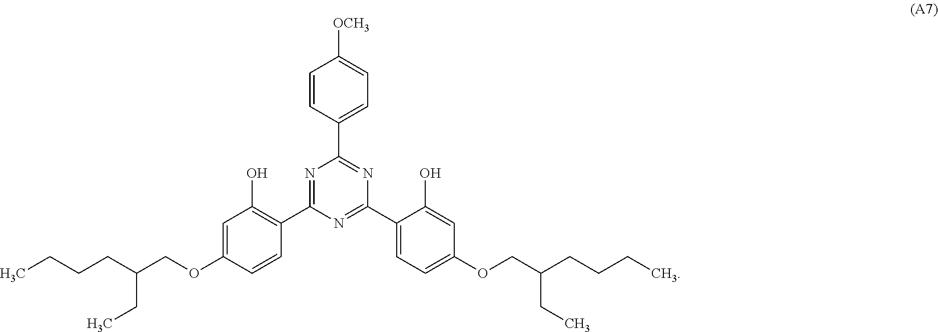 [SMILES: CCCCC(CC)COc1ccc(-c2nc(-c3ccc(OC)cc3)nc(-c3ccc(OCC(CC)CCCC)cc3O)n2)c(O)c1]

5. The composition according to claim 1, wherein the at least one hindered amine light stabilizer is selected from formulae (H1), (H2), (H3) and/or compound (H4): 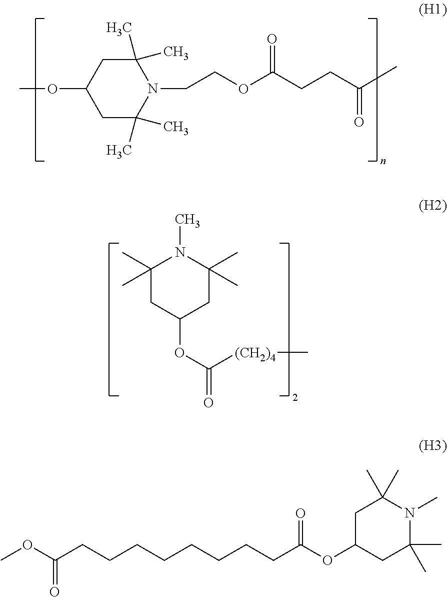
and
wherein the compound (H4) is a reaction product of 1,2,2,6,6-pentamethylpiperidin-4-ol, diethylcarbonate, and ethoxylated trimethylolpropane.

6. The composition according to claim 1, wherein the at least one UV absorber is selected from formulae (U1) to (U7):

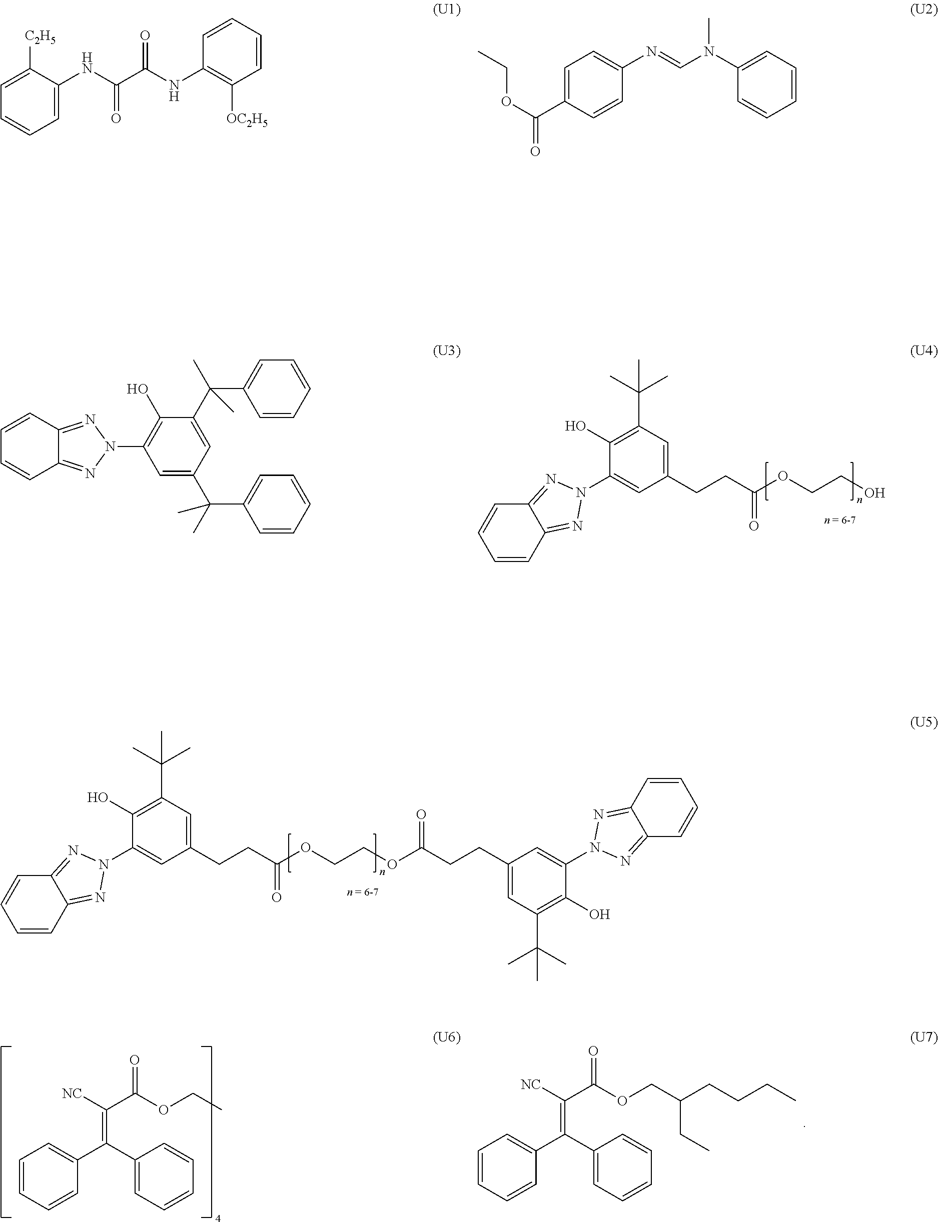

7. The composition according to claim 1, wherein the polyurethane is an aromatic polyurethane.

8. The composition according to claim 1, wherein the polyurethane is a polyurethane foam, a thermoplastic polyurethane, or a polyurethane coating.

9. The composition according to claim 1, wherein the composition comprises the at least one UV absorber, the at least one hindered amine light stabilizer and the at least one phenyl triazine of formula (A) in a total amount of 0.01 to 15.0 wt %.

10. The composition according to claim 1, wherein the composition comprises the at least one UV absorber in a total amount of 0.001 to 10.0 wt %.

11. The composition according to claim 1, wherein the composition comprises the at least one hindered amine light stabilizer in a total amount of 0.001 to 10.0 wt %.

12. The composition according to claim 1, wherein the composition comprises the at least one phenyl triazine of formula (A) in a total amount of 0.001 to 5.0 wt %.

13. A process for preparing the composition as defined in claim 1, comprising the contacting the polyurethane and
the at least one UV absorber,
the at least one hindered amine light stabilizer, and
the at least one phenyl triazine of formula (A).

14. A process for stabilizing the polyurethane as defined in claim 1, comprising incorporating into the polyurethane
the at least one UV absorber, as defined in claim 1,
the at least one hindered amine light stabilizer, as defined in claim 1, and
the at least one phenyl triazine of formula (A) as defined in claim 1.

15. The method of claim 14, wherein the method is for stabilizing the polyurethane against degradation by light, oxygen and/or heat.
